(19) United States
(12) Patent Application Publication
(10) Pub. No.: US 2021/0240166 A1
(43) Pub. Date: Aug. 5, 2021

(54) SYSTEMS FOR AUTONOMOUS OPERATION OF A PROCESSING AND/OR MANUFACTURING FACILITY

(71) Applicant: ExxonMobil Research and Engineering Company, Annandale, NJ (US)

(72) Inventors: Apostolos T. Georgiou, Spring, TX (US); Kiran R. Sheth, Sugar Land, TX (US); George A. Khoury, Beaumont, TX (US); Onur Onel, Houston, TX (US)

(21) Appl. No.: 17/148,732

(22) Filed: Jan. 14, 2021

Related U.S. Application Data
(60) Provisional application No. 62/967,760, filed on Jan. 30, 2020.

(51) Int. Cl. G05B 19/4155; G06N 3/08; G06N 20/20

(52) U.S. Cl. CPC G05B 19/4155; G05B 2219/31368; G06N 20/20; G06N 3/08

(57) ABSTRACT

A method for operating a processing/manufacturing facility (e.g., processing/manufacturing facility) may comprise: collecting operational conditions in a processing/manufacturing facility from one or more automated systems and/or sensors; communicating the operational conditions to one or more of a plurality of agents that comprise an adaptive analytical model, wherein the plurality of agents comprises an agent selected from the group consisting of: a software sensor agent, a base control stability agent, an alarm agent, a transient process agent, an advanced control optimization agent, a computer vision agent, a display agent, an integrator/orchestrator agent, and any combination thereof; and deriving data, instructions for changing operational parameters of a process of the processing/manufacturing facility, and/or recommendations for changing operational parameters of the process of the processing/manufacturing facility using the adaptive analytical models of the agents.

### CROSS REFERENCE TO RELATED APPLICATION

The application relates and claims priority to U.S. Provisional Patent Application 62/967,760, filed on Jan. 30, 2020, and is incorporated herein specifically by reference.

### FIELD

The present application relates to an autonomous operation of a processing and/or manufacturing facility, preferably a chemical processing and/or manufacturing facility.

### BACKGROUND

Petroleum and chemical processing and/or manufacturing facilities (also referred to herein as processing/manufacturing facilities) are typically sites where a variety of processes can occur such as producing, refining, synthesizing, formulating, blending, and/or storing petroleum, refined products and chemicals (e.g., fuels such as gasoline, diesel, and kerosene; commodity and specialty chemicals such as olefins, aromatics, monomers, polymers, surfactants, dyes and pigments, and fertilizers; catalysts; and the like). Individual processes may be independent or interconnected. For example, the steam stream produced in one process may be used for heating a stream (e.g., via heat exchange) in another process. Whether the processing/manufacturing facility has one or more processes occurring, the processes are highly monitored to maintain reliable operation of the facility, promote worker and environmental safety, and mitigate upsets when equipment breaks down or production units are shut off, restarted, and repaired.

Of late, several computer-based technologies have been developed that monitor and/or control portions of the processes going on. For example, in polymer production, automated systems are available that measure or derive the conditions (e.g., temperature, pressure, monomer concentration, and the like) in the reactor. Separate automated systems are also available for measuring and controlling the properties of the resultant polymer. Depending on the processes involved, a processing/manufacturing facility can include dozens of separate automated systems, which typically only provide data outputs and have limited, if any, direct communication between each other.

The outputs from these automated systems are provided to the operator who monitors the conditions of the processes. The operator further makes adjustments to process conditions (e.g., changing temperature or monomer feed rate) to achieve the desired product and to remedy or mitigate upsets. That is, the operator takes in the data from the separate automated systems and determines how to operate the processing/manufacturing facility or individual processes thereof Therefore, there is significant room for human error that causes a decrease in margins either from upsets or inefficient facility operation.

### SUMMARY

The present application relates to an autonomous operation of a processing and/or manufacturing facility, preferably a processing and/or manufacturing facility.

A method of the present disclosure may comprise: collecting operational conditions in a processing/manufacturing facility from one or more automated systems and/or sensors; communicating the operational conditions to one or more of a plurality of agents that comprise an adaptive analytical model, wherein the plurality of agents comprises an agent selected from the group consisting of: a software sensor agent, a base control stability agent, an alarm agent, a transient process agent, an advanced control optimization agent, a computer vision agent, a display agent, an integrator/orchestrator agent, and any combination thereof; and deriving data, instructions for changing operational parameters of a process of the processing/manufacturing facility, and/or recommendations for changing operational parameters of the process of the processing/manufacturing facility using the adaptive analytical models of the agents.

A system of the present disclosure may comprise: a processor; a memory coupled to the processor; and instructions provided to the memory, wherein the instructions are executable by the processor to perform the foregoing method.

A processing/manufacturing facility of the present disclosure may comprise: one or more automated systems and/or sensors (automated systems/sensors) that monitor operational conditions and/or operate hardware of the processing/manufacturing facility; and a plurality of agents that comprise an adaptive analytical model and that communicate with the one or more automated systems/sensors to receive data from the one or more automated systems/sensors, wherein the plurality of agents comprises an agent selected from the group consisting of: a software sensor agent, a base control stability agent, an alarm agent, a transient process agent, an advanced control optimization agent, a computer vision agent, a display agent, and any combination thereof, and wherein the adaptive model produces data, instructions for changing operational parameters of a process of the processing/manufacturing facility, and/or recommendations for changing operational parameters of the process of the processing/manufacturing facility.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a diagram of a nonlimiting example integration of automated systems/sensors and agents in an autonomous operation system of a processing/manufacturing facility.

FIG. 2 is a diagram of a nonlimiting example integration of automated systems/sensors and agents in an autonomous operation system of a processing/manufacturing facility.

FIG. 3 is a diagram of a nonlimiting example integration of automated systems/sensors and agents in an autonomous operation system of a processing/manufacturing facility.

FIG. 4 is a diagram of a nonlimiting example integration of automated systems/sensors and agents in an autonomous operation system of a processing/manufacturing facility.

### DETAILED DESCRIPTION

The present application relates to an autonomous operation of a processing and/or manufacturing facility, preferably a processing and/or manufacturing facility. Herein, a “processing/manufacturing facility” encompasses a facility for producing, refining, manufacturing, synthesizing, formulating, blending, processing, and/or storing on petroleum, refined products and derivatives, and chemicals (preferably petroleum and/or petrochemicals). Specific examples include, but are not limited to, fuels such as gasoline, diesel, and kerosene; commodity and specialty chemicals such as olefins, aromatics, monomers, polymers, surfactants, dyes and pigments, and fertilizers; catalysts; and the like; and any combination thereof. While the methods and systems described herein reference petroleum and petrochemical processing/manufacturing facilities, the methods and systems described herein can be extended to other processing/manufacturing facilities.

The autonomous operations described herein use agents that receive data (historical and real-time) related to the various processes (e.g., from databases, sensors, automated systems, other agents, and the like), analyze the data, and provide operating recommendations and/or take actions for operating the processing/manufacturing facility. Autonomous operation of processing/manufacturing facilities will reduce human error that leads to unplanned capacity losses and upsets.

As used herein, the term “automated system” refers to a system that is pre-programmed to perform specific functions and does not include programming that learns. Examples of functions include, but are not limited to, measuring a condition of a process at specific intervals or in response to a specific trigger, adjusting operating conditions at a specific time or in response to a specific trigger, performing programmed analytical analyses (e.g., calculating a value for a first condition based on a measurement of a second condition), alarming when a condition is outside the bounds, calculating the value of multiple inputs based on constraints and economics, changing process conditions based on predefined sequence, and the like, and any combination thereof.

As used herein, the term “agent” refers to a system that performs adaptive analytical analyses based on current conditions and historical data and provides operating recommendations and/or takes actions for operating the processing/manufacturing facility.

The adaptive analytical analyses of the agents can be based on neural networks, decision trees/random forest methods, kernal methods, reinforcement learning methods, and the like, and any ensemble thereof. Examples of neural networks include, but are not limited to, perception, feed forward, radial basis, deep feed forward, recurrent neural network, long-short term memory, gated recurrent unit, auto encoder, variational auto encoder, denoising auto encoder, sparse auto encoder, Markov chain, Hopfield network, Boltzmann machine, restricted Botzmann machine, deep belief network, deep convolutional network, deconvolutional network, deep convolutional inverse graphics network, generative adversarial network, liquid state machine, extreme learning machine, echo state network, deep residual network, Kohonen network, support vector machine, neural turning machine, and the like. Example of kernal methods include, but are not limited to, kernel perceptron, Gaussian processes, principal components analysis, canonical correlation analysis, ridge regression, spectral clustering, linear adaptive filters, and the like.

Examples of agents include, but are not limited to, a fingerprinting agent, a software sensor agent, a base control stability agent, an alarm agent, a transient process agent, an advanced control optimization agent, a computer vision agent, a display agent, an integrator/orchestrator agent, and the like, and any combination thereof.

A fingerprinting agent is an adaptive analytical model that receives real-time operational conditions and historical data of a specific process mode and determines the optimal (best-demonstrated) process behavior at that mode. The fingerprint agent then guides the operator who may change operational parameters to maintain the real-time measured operation conditions within the fingerprint of that process mode

A software sensor agent is an adaptive analytical model that derives a property of a based on measured values. For example, the melt index of a polymer is difficult to measure in real-time during the production of the polymer. However, measured values like hydrogen concentration, temperature, and pressure relate to the melt index of a polymer. An algorithm or other mathematical representation can be the software sensor agent that uses inputs like the hydrogen concentration, temperature, and pressure relate to calculate the melt index of the polymer. Over time, the software sensor agent may incorporate the most recent data in consideration and re-learns the relation between measured values and the property being calculated.

Base controls are a set of automated systems that a process has to keep the plants at desired operating conditions. The health of these systems may deteriorate over time due to upsets, disturbances, and the like.

Base control health is a set of conditions that a process or specific piece of equipment that describes the health and operation of process/equipment. During operations, the base controls may oscillate and react to changes of other operational conditions that reduce health of base controls. For example, a polyethylene reactor may have temperature, pressure, and space velocity base controls that should be monitored during polymer production as key indicators of the health and operation of the reactor. These values may oscillate or become unstable over time during the polymer production process. Further, changing other conditions of the process like catalyst feed rate can change the stability of base controls. A base control stability and optimization agent is an adaptive analytical model that receives data (historical and real-time) related to each base control and optionally other operational parameters that affect the base controls, analyze the data (which again is oscillatory) to (a) identify when oscillations are normal or indicatable of instability and/or (b) identify if changes to operational parameters will improve efficiency, and (c) provide operation recommendations and/or take operational actions in response to the analysis of the data. For example, relative to the previous polyethylene production example, if an instability in temperature is identified, the operational recommendation/operational action may be to reduce, or even stop, catalyst feed, fix the instrumentation associated with catalyst feed, or re-tune the response of catalyst feed to temperature. In another example, the analysis may identify that an increase in catalyst feed rate and increase in diluent flow rate improves the efficiency of the polymer production while maintaining the base control health within prescribed values.

Processing/manufacturing facilities use alarms to signal upsets, signal operating conditions being outside prescribed limits, signal undesired conditions, signal conditions when automated systems cannot keep the facility within alarm limits (hence alarming that human intervention is required), and the like, and any combination thereof. Some alarms are critical alarms and others may be nuisance alarms. For example, an alarm related to a reactor temperature being too high may be a critical alarm that requires immediate action, while a storage tank level alarm may not be as time-sensitive. An alarm agent is an adaptive analytical model that receives real-time alarm data (e.g., which alarm, time of the alarm, and the like) and historical alarm data (e.g., which alarm, time of the alarm, frequency of alarm occurrence, operator reactions to the stop the alarm, and the like), analyzes the data, and provides outputs like (a) operational recommendations and/or take operational actions to stop the alarm, (b) a list of alarms based on importance and/or ease of remedy via operational actions, and (c) current status and statistics related to previous alarms.

A transient process is a process occurring when operating parameters are being changed before, after, or between designated processes when the operating parameters set to produce the desired product, that is, when the operating parameters are in transition. Startup processes, shutdown processes, and what is occurring when operating parameters are changed between two set processes are examples of transient processes. Transient processes are generally implemented based on the operating engineer's experiences with high variability between how each operating engineer approaches the same transient process. A transient process agent is an adaptive analytical model that receives real-time operational conditions and historical data on the same or similar transient process and analyzes the data to provide recommended paths with corresponding thresholds for how individual operational parameters should change through the progress of the transient process. This provides a guide to the operator who may change operational parameters to maintain the real-time measured operation conditions within the thresholds. Such methods and systems advantageously have real-time benchmarking (comparison of the proposed path/thresholds with real-time measurements) that guide the operator to mitigate upsets and more efficiently perform the transient process.

A processing/manufacturing facility can be controlled and optimized using automated systems such as model predictive controller (MPC) and real-time optimizer (RTO). An advanced control optimization agent is an adaptive analytical model that receives real-time operational data (e.g., operational conditions, equipment/processes that are offline (e.g., for maintenance), operating efficiency of equipment/processes, and the like) and historical operational data, analyzes the data for more efficient operation of the process/equipment to which the MPC and/or RTO is associated, and provides operation recommendations to update the MPC and/or RTO and/or takes operational actions to update the MPC and/or RTO. A semantic AI agent is a decision-tree like agent that performs knowledge automation and decision-making tasks through the comprehension of non-numerical data. As an example, this agent checks different plant modes and conditions to determine what constraints need to be pushed and what changes are necessary to help accomplish that. Hence, the agent provides a semantic description of the situation and the recommended action.

When operating a processing/manufacturing facility, not all operational conditions are values like temperature and flow rate are. Some operational conditions are non-sensible, which refers to something that cannot be measured or sensed using typical (common) thermodynamic sensors or gauges that output a measured numeric value. Examples of non-sensible process conditions include, but are not limited to, the polymer level (height) in a polymer extruder, stability of flames emitted from a furnace burner or flare stack, and smoke measurement (e.g., quantity or presence) in a flame emitted from a flare stack. For example, real-time images and/or video can be used to visualize non-sensible operational conditions. A computer vision agent is an adaptive analytical model that receives real-time non-sensible data and historical non-sensible data and analyzes the data to produce a numeric state (or value) that describes the non-sensible data and is more suitable for computer application-based control and/or analytics.

The operating control center and other operational control areas often include several monitors or displays that illustrate (e.g., with numbers, graphs, charts, or the like) the status of various operating parameters and/or outputs of analyses of the process. Most of the time, there is more information available than can be reasonably displayed. A display agent is an analytical model that receives data (e.g., outputs from automated systems or other agents, real-time operational conditions, alarms occurring, the operator interacting with the displays, and the like) and analyzes the data to recommend displays for viewing and/or change the display view. For example, over time the display agent may learn an operator's display viewing habits and preferences for different scenarios and change the display view accordingly. In another example, the alarm response agent may provide to the display agent a list of critical alarms that require immediate attention, and the display agent may display the most pertinent operational parameters for the operator and/or recommendations to stop the alarm.

Each agent typically is skilled in a specific task based on the information it receives from other agents and/or automated systems. However, the task that a specific agent is skilled in may not apply under every scenario. For example, when a plant is in upset mode, the alarm agent needs to take/recommend necessary actions, while advanced control optimization agents tasks might be secondary. To coordinate, an integrator/orchestrator agent is an agent that understands the plant state based on the information it receives from the other agents and/or automated systems, decides on what objectives each agent should be pursuing (if any), and makes sure agents perform aligned tasks as opposed to conflicting tasks.

The foregoing are nonlimiting examples of agents that can be used for the autonomous operation of a processing/manufacturing facility. Each of the agents may be trained using data (e.g., operational conditions and operator actions) in previous processes. Alternatively or in addition to the historical data, operators can use a simulator to simulate different scenarios. The simulated scenarios and operator's reactions to the simulated scenarios can also be used in training the agents.

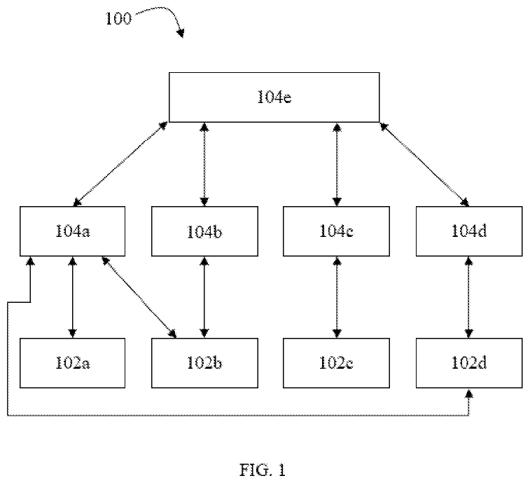

FIG. 1 is a diagram of a nonlimiting example integration 100 of automated systems/sensors 102a-d and agents 104a-e in an autonomous operation system of a processing/manufacturing facility (e.g., processing/manufacturing facility). In the figures, the term “automated systems/sensors” is used to encompass automated systems, sensors, and the like. That is, components of the facility that provide data regarding the operational parameters and/or operational conditions and, if programmed for more than simple measurements, are pre-programmed to perform specific functions.

The illustrated integration 100 has a two-tier agent analysis. Four automated systems/sensors 102a-d communicate with four agents 104a-104d to provide data to the agents to 104a-104d. Any number of automated systems/sensors can provide data to any number of agents. The four agents 104a-104d also communicate with a fifth agent 104e to provide data to the fifth agent 104e. Such data may be the recommendations of the individual agents 104a-104d, data derived from the analyses of the individual agents 104a-104d, and the like. The fifth agent 104e may perform additional analyses on this data to yield recommendations and/or take actions regarding the operation of the manufacturing plant.

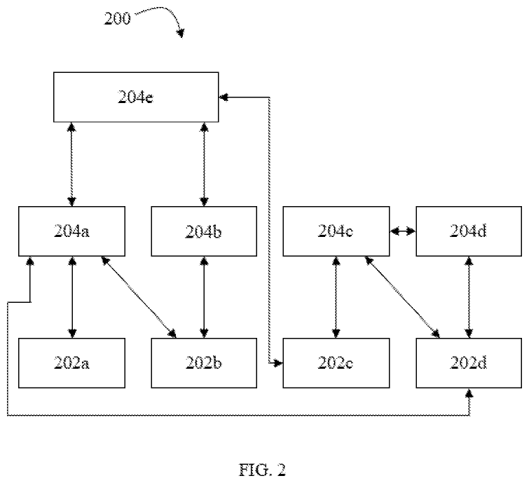

FIG. 2 is a diagram of another nonlimiting example integration 200 of automated systems/sensors 202a-d and agents 204a-e in an autonomous operation system of a processing/manufacturing facility (e.g., processing/manufacturing facility). The illustrated integration 200 has two automated systems/sensors 202a-b that provide data to agents 204a-b. Automated systems/sensors 202d also provides data to agent 204a. Agents 204a-b and automated systems/sensor 202c provide data to agent 204e. Separately, agents 204c-d collect data from automated systems/sensor 202c-d. Agents 204c-d also communicate with each other to share data.

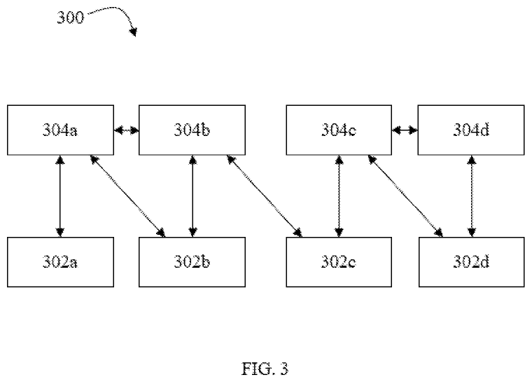

FIG. 3 is a diagram of yet another nonlimiting example integration 300 of automated systems/sensors 302a-d and agents 304a-d in an autonomous operation system of a processing/manufacturing facility (e.g., processing/manufacturing facility). The illustrated integration 300 has three automated systems/sensors 302a-c that provide data to agents 304a-b. Agents 304a-b also communicate with each other to share data. Further, agents 304c-d collect data from automated systems/sensors 302c-d. Agents 304c-d also communicate with each other to share data. In this example, agents 304a-b and agents 304c-d are independent. For example, agents 304a-b may be related to a first process in the processing/manufacturing facility, and agents 304c-d may be related to a second process in the processing/manufacturing facility. However, a product or by-product in the second process may be used in the first process, so agent 304b collects data related to said product or by-product.

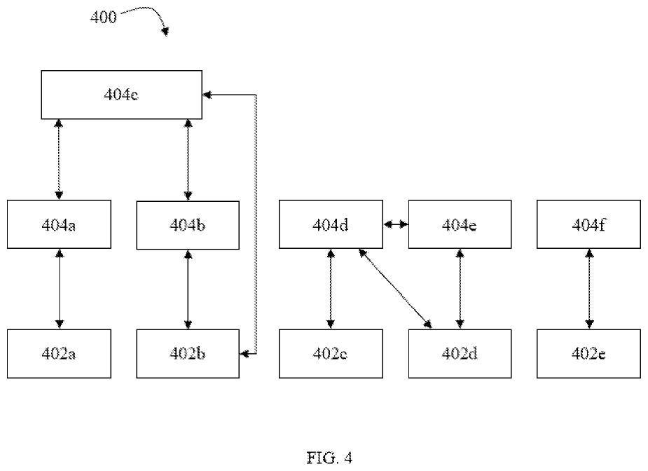

FIG. 4 is a diagram of another nonlimiting example integration 400 of automated systems/sensors 402a-d and agents 404a-f in an autonomous operation system of a processing/manufacturing facility (e.g., processing/manufacturing facility). The illustrated integration 400 has three separate integrations. First, automated systems/sensors 402a-b communicate with agents 404a-b to provide data to the agents 404a-b. Further, agents 404a-b communicate with agent 404c to provide data to agent 404c. Second, automated systems/sensors 402c-d communicate with agents 404c-d to provide data to the agents 404c-d. Further, agents 404c-d communicate with each other. Finally, automated systems/sensor 402e communicates with agent 404f to provide data to agent 404f In this example, agents 404a-c, agents 404d-e, and agent 404f do not communicate directly or indirectly.

The foregoing are nonlimiting examples of how agents and automated systems/sensors can be integrated for autonomous operation system of a processing/manufacturing facility (e.g., processing/manufacturing facility). In the figures, the communication arrows are both ways. That is, as illustrated, data can flow from automated systems/sensors to agents and between agents. Also, recommendations and/or instructions for taking actions (e.g., changing a temperature set point or changing a flow rate) may flow from the agents to the automated systems/sensors and between agents. While communication is illustrated as two-way, the interaction may be only one-way where data is provided from an automated system/sensor to agents and from one agent to another. For example, a temperature sensor may only provide a measurement to an agent where reverse communication is not needed.

Communications between various parts of the autonomous operation system including to and from an operator may be wired or wireless. By way of example, and not limitation, communication media includes wired media such as a wired network or direct-wired connection, and wireless media such as acoustic, RF, infrared, and other wireless media.

An operator and the agents can decide which actions to take (e.g., changes in operational parameters) to any desired degree. For example, agents may provide only recommendations for the operator to approve all actions. In another example, a portion of the decisions may be made by the agents while other decisions may be made by the operator, which may be based on the recommendations from the operator. In yet another example, the agents may make most or all of the decisions while an operator monitors the processing/manufacturing facility and can override the agents as needed.

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

The methods described herein can, and in many embodiments must, be performed using computing devices or processor-based devices that include a processor; a memory coupled to the processor; and instructions provided to the memory, wherein the instructions are executable by the processor to perform the methods described herein (such computing or processor-based devices may be referred to generally by the shorthand “computer”). For example, a system may comprise: a processor; a memory coupled to the processor; and instructions provided to the memory, wherein the instructions are executable by the processor to collect operational conditions in a processing/manufacturing facility (e.g., processing/manufacturing facility) from one or more automated systems/sensors; communicate the operational conditions to one or more of a plurality of agents that comprise an adaptive analytical model, wherein the plurality of agents comprises an agent selected from the group consisting of: a software sensor agent, a base control stability agent, an alarm agent, a transient process agent, an advanced control optimization agent, a computer vision agent, a display agent, an integrator/orchestrator agent, and any combination thereof; and derive data, instructions for changing operational parameters of a process of the processing/manufacturing facility, and/or recommendations for changing operational parameters of the process of the processing/manufacturing facility using the adaptive analytical models of the agents.

Similarly, any calculation, determination, or analysis recited as part of methods described herein may be carried out in whole or in part using a computer.

Furthermore, the instructions of such computing devices or processor-based devices can be a portion of code on a non-transitory computer readable medium. Any suitable processor-based device may be utilized for implementing all or a portion of embodiments of the present techniques, including without limitation personal computers, networks, laptop computers, computer workstations, mobile devices, multi-processor servers or workstations with (or without) shared memory, high performance computers, and the like. Moreover, embodiments may be implemented on application specific integrated circuits (ASICs) or very large scale integrated (VLSI) circuits.

### Example Embodiments

A first non-limiting example embodiment of the present disclosure is a method comprising: collecting operational conditions in a processing/manufacturing facility (e.g., processing/manufacturing facility) from one or more automated systems and/or sensors (automated systems/sensors); communicating the operational conditions to one or more of a plurality of agents that comprise an adaptive analytical model, wherein the plurality of agents comprises an agent selected from the group consisting of: a software sensor agent, a base control stability agent, an alarm agent, a transient process agent, an advanced control optimization agent, a computer vision agent, a display agent, an integrator/orchestrator agent, and any combination thereof; and deriving data, instructions for changing operational parameters of a process of the processing/manufacturing facility, and/or recommendations for changing operational parameters of the process of the processing/manufacturing facility using the adaptive analytical models of the agents. The first nonlimiting example embodiment may include one or more of: Element 1: the method further comprising communicating the data from one of the plurality of agents to another; Element 2: the method further comprising communicating the recommendations for changing operational parameters of the process of the processing/manufacturing facility to an operator; and changing the operational parameters of the process based on the recommendations; Element 3: the method further comprising communicating the instructions for changing operational parameters of the process of the processing/manufacturing facility to the automated systems/sensors or related hardware; and Element 4: wherein the adaptive analytical models are independently based on neural networks, decision trees/random forest methods, kernal methods, reinforcement learning methods, and any ensemble thereof. Examples of combinations include, but are not limited to, Element 1 in combination with one or more of Elements 2-4; Element 2 in combination with one or more of Elements 3-4; and Elements 3 and 4 in combination.

A second non-limiting example embodiment of the present disclosure is a system comprising: a processor; a memory coupled to the processor; and instructions provided to the memory, wherein the instructions are executable by the processor to perform the method of the first non-limiting example embodiment optionally including one or more of Elements 1-4.

A third non-limiting example embodiment of the present disclosure is a processing/manufacturing facility (e.g., processing/manufacturing facility) comprising: one or more automated systems and/or sensors (automated systems/sensors) that monitor operational conditions and/or operate hardware of the processing/manufacturing facility; and a plurality of agents that comprise an adaptive analytical model and that communicate with the one or more automated systems/sensors to receive data from the one or more automated systems/sensors, wherein the plurality of agents comprises an agent selected from the group consisting of: a software sensor agent, a base control stability agent, an alarm agent, a transient process agent, an advanced control optimization agent, a computer vision agent, a display agent, and any combination thereof, and wherein the adaptive model produces data, instructions for changing operational parameters of a process of the processing/manufacturing facility, and/or recommendations for changing operational parameters of the process of the processing/manufacturing facility. The third nonlimiting example embodiment may include one or more of: Element 5: wherein two or more of the plurality of agents communicate with each other; Element 6: wherein the at least one of the plurality of agents communicates the instructions for changing operational parameters of the process of the processing/manufacturing facility to the automated systems/sensors or related hardware; Element 7: wherein the at least one of the plurality of agents communicates the recommendations for changing operational parameters of the process of the processing/manufacturing facility to an operator; and Element 8: wherein the adaptive analytical models are independently based on neural networks, decision trees/random forest methods, kernal methods, reinforcement learning methods, and any ensemble thereof. Examples of combinations include, but are not limited to, Element 5 in combination with one or more of Elements 6-8; Element 6 in combination with one or more of Elements 7-8; and Elements 7 and 8 in combination.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
collecting operational conditions in a processing/manufacturing facility from one or more automated systems and/or sensors (automated systems/sensors);
communicating the operational conditions to one or more of a plurality of agents that comprise an adaptive analytical model, wherein the plurality of agents comprises an agent selected from the group consisting of: a software sensor agent, a base control stability agent, an alarm agent, a transient process agent, an advanced control optimization agent, a computer vision agent, a display agent, an integrator/orchestrator agent, and any combination thereof; and
deriving data, instructions for changing operational parameters of a process of the processing/manufacturing facility, and/or recommendations for changing operational parameters of the process of the processing/manufacturing facility using the adaptive analytical models of the agents.

2. The method of claim 1 further comprising:
communicating the data from one of the plurality of agents to another.

3. The method of claim 1 further comprising:
communicating the recommendations for changing operational parameters of the process of the processing/manufacturing facility to an operator; and
changing the operational parameters of the process based on the recommendations.

4. The method of claim 1 further comprising:
communicating the instructions for changing operational parameters of the process of the processing/manufacturing facility to the automated systems/sensors or related hardware.

5. The method of claim 1, wherein the adaptive analytical models are independently based on neural networks, decision trees/random forest methods, kernal methods, reinforcement learning methods, and any ensemble thereof.

6. A processing/manufacturing facility comprising:
one or more automated systems and/or sensors (automated systems/sensors) that monitor operational conditions and/or operate hardware of the processing/manufacturing facility; and
a plurality of agents that comprise an adaptive analytical model and that communicate with the one or more automated systems/sensors to receive data from the one or more automated systems/sensors, wherein the plurality of agents comprises an agent selected from the group consisting of: a software sensor agent, a base control stability agent, an alarm agent, a transient process agent, an advanced control optimization agent, a computer vision agent, a display agent, and any combination thereof, and wherein the adaptive model produces data, instructions for changing operational parameters of a process of the processing/manufacturing facility, and/or recommendations for changing operational parameters of the process of the processing/manufacturing facility.

7. The processing/manufacturing facility of claim 6, wherein two or more of the plurality of agents communicate with each other.

8. The processing/manufacturing facility of claim 6, wherein the at least one of the plurality of agents communicates the instructions for changing operational parameters of the process of the processing/manufacturing facility to the automated systems/sensors or related hardware.

9. The processing/manufacturing facility of claim 6, wherein the at least one of the plurality of agents communicates the recommendations for changing operational parameters of the process of the processing/manufacturing facility to an operator.

10. The processing/manufacturing facility of claim 6, wherein the adaptive analytical models are independently based on neural networks, decision trees/random forest methods, kernal methods, reinforcement learning methods, and any ensemble thereof.
